(19) United States
(12) Patent Application Publication
(10) Pub. No.: US 2011/0164876 A1
(43) Pub. Date: Jul. 7, 2011

(54) DIRECTIONLESS RECONFIGURABLE OPTICAL ADD/DROP MULTIPLEXER

(75) Inventors: Junichiro FUJITA, Cambridge, MA (US); Reinald Gerhardt, Wakefield, MA (US); Fang Wang, Acton, MA (US); Jiandong Shi, Methuen, MA (US)

(73) Assignee: ENABLENCE USA COMPONENTS, INC.

(21) Appl. No.: 12/985,934

(22) Filed: Jan. 6, 2011

Related U.S. Application Data
(63) Continuation-in-part of application No. 12/573,063, filed on Oct. 2, 2009.
(60) Provisional application No. 61/102,266, filed on Oct. 2, 2008.

(51) Int. Cl. H04J 14/02

(52) U.S. Cl. 398/48; 398/83

(57) ABSTRACT

An optical switch system for dropping a ROADM node is presented. The switch system includes an N×M structure having two layers. A first layer includes optical splitters, each splitter receiving a multiplexed input signal and outputting a first multiplexed output signal. A second layer includes switches receiving the first multiplexed output signals from the optical splitters and generating a second multiplexed output signal. The second multiplexed output signal is typically one of the first multiplexed output signals. An optional third layer, which includes optical filters, receives the second multiplexed output signal from the switches and produces a non-multiplexed, single-wavelength output signal.

### CROSS-REFERENCE TO RELATED APPLICATIONS

This is a Continuation-in-Part application of U.S. Ser. No. 12/573,063 filed on Oct. 6, 2009, which in turn claims the benefit of U.S. Provisional Application No. 61/102,266 filed on Oct. 2, 2008 that is entitled “Switch Fabrics for Directionless Reconfigurable Optical Add/Drop Multiplexing Networks.” Both applications are hereby incorporated by reference in their entirety.

### FIELD OF INVENTION

The present invention relates generally to optical communication systems and more specifically to optical systems with reconfigurable optical add/drop multiplexers.

### BACKGROUND

Reconfigurable optical add-drop multiplexers (ROADMs) are a form of optical add-drop multiplexer that adds the ability to remotely and dynamically switch traffic from a wavelength-division multiplexed (WDM) system at the wavelength layer. ROADMs have a multitude of uses in optical systems. For example, ROADMs may be useful in the field of WDM light wave systems for selective broadcasting, dropping, and monitoring of discrete wavelengths. More specifically, ROADMs allow individual wavelengths carrying data channels to be added and dropped from a fiber without the need to convert the signals on all of the WDM channels to electronic signals and back again to optical signals.

The flexibility of current ROADM systems is limited because the Drop end is not really directionless, colorless and contentionless. For example, ROADM cannot be configured to freely drop any wavelength from any input ports. A method and apparatus that would allow this type of configuring is desired.

### SUMMARY

In one aspect, an optical switching system for switching optical signals between N first ports and M second ports is provided that includes N number of 1×Y optical splitters, each optical splitter providing one of the N first ports, and M number of Z×1 optical switches, each optical switch optically connected to at least one optical splitter and providing one of the M second ports, where Y is any natural number and Z is any natural number. In the optical switching system, Z may be the number of optical splitters to which an optical switch is optically connected. Y may be the same for each optical splitter or Y for one of the optical splitters may be the same or different as the Y for the other N number of optical splitters. Z may be the same for each optical switch or Z is for one of the optical switches may be the same or different as the Z for the other M number of optical switches. In one aspect, Y equals M, Z equals N, and each optical splitter is optically connected to each optical switch.

Each of the optical splitters is configured to receive an input multiplexed signal having a set of wavelengths and to split the input multiplexed signal into Y number of output multiplexed signals, and each of the optical switches is configured to receive one output multiplexed signal from 1 to N number of the optical splitters, to select one of the 1 to N number of output multiplexed signals received, and to output the selected output multiplexed signal.

The optical switching system may further include tunable filters, each of the tunable filters optically connected to one of the M number of optical switches and capable of passing a preselected wavelength range from a selected multiplexed signal received by the tunable filter.

Each of the optical switches is configured to receive an input signal, the input signal having a set of wavelengths that is the same or different for each optical switch, to select one of the N number of optical splitters to output the input signal to, and to output the input signal to one of the N number of optical splitters, and each of the optical splitters is configured to receive one or more input signals and output a multiplexed signal containing a group of wavelengths that includes the sets of wavelengths provided by the input signals received by the optical splitter. The set of wavelengths for one or more of the input signals may be a single wavelength.

The optical switching system may further include up to M number of optical amplifiers each optically connected to one of the optical switches.

The optical switching system may further include up to M number of optical amplifiers each optically connected to one of the optical switches and one of the tunable filters.

The optical switching system may further include up to M number of optical amplifiers, each optically connected to one of the tunable filters.

The optical switching system may further include up to N number of optical amplifiers, each optically connected to one of the optical splitters.

The optical switching system may further include up to N number of optical amplifiers, each optically connected to one of the optical switches and one of the optical splitters.

The optical switching system may include up to P tunable filter modules, each tunable filter module including T number of tunable filters capable of passing a preselected wavelength range from a selected multiplexed signal received by the tunable filter, each tunable filter module capable of being attached and detached from the T optical switches as a unit to optically connect each of the T number of tunable filters to one of the M number of optical switches, where T<M and P=M/T. The tunable filter module further includes T number of amplifiers each optically connected to one of the tunable filters.

The optical switching system may include a drop section, comprising a portion of the N optical splitters and the M optical switches, wherein each optical splitter of the portion of the N optical splitters is configured to receive an input multiplexed signal having a set of wavelengths and split the input multiplexed signal into Y number of output multiplexed signals, each of the output multiplexed signals having the same set of wavelengths as the input multiplex signal, and each optical switch of the portion of M optical switches is configured to receive one output multiplexed signal from each of the optical splitters of the portion of the N optical splitters, select one of the output multiplexed signals, and output the selected output multiplexed signal; and an add section, comprising a second portion of the N optical splitters and M optical switches, wherein up to the second portion of M optical switches are configured to receive an optical signal having a set of wavelengths and output the received optical signal to one of the second portion of N optical splitters, each the second portion of N optical splitters is configured to combine the optical signals received from the optical switches into a single multiplexed signal containing the sets of wavelengths provided by the optical signals received by the optical splitter.

In the optical switching system, the optical splitters may be combined into a splitter array unit and the optical switches may be combined into an optical switch module, and the optical switch module can be attached and detached from the splitter array unit. The optical switch module may further include a plurality of tunable filters, one tunable filter optically connected to each optical switch and each tunable filter capable of passing a preselected wavelength range from a selected multiplexed signal received by the tunable filter. The optical switch module may further include a plurality of amplifiers, each amplifier optically connected to each optical switch.

The optical switching system may further include a plurality of 1×K optical splitters, wherein each 1×K optical splitter is optically connected to the input port of each of the N 1 ×Y optical splitters.

In another aspect, a K(N×M) optical switching system is provided that includes K number of 1 ×X optical splitters, where X is any natural number and may be different for each optical splitter; N number of 1 ×Y optical splitters, where Y is any natural number and may be different for each optical splitter; and M number of Z×1 optical switches, where Z is a any natural number and may be different for each optical switch, where each of the 1 ×Y optical splitters is optically connected to a different channel X of the 1 ×X optical splitters, and each of the Z channels of each optical switch is optically connected to different 1 ×Y optical splitter. In the optical switching system, N may be equal to (K)(X). In one aspect, Y equals M, Z equals N, and each optical splitter is optically connected to each optical switch.

The K×(N×M) optical switching system may further include a plurality of tunable filters each connected to one of the Z×1 optical switches.

The K×(N×M) optical switching system may further include a drop section, comprising a portion of the N optical splitters and the M optical switches, wherein each optical splitter of the portion of the N optical splitters is configured to receive an input multiplexed signal having a set of wavelengths and split the input multiplexed signal into Y number of output multiplexed signals, each of the output multiplexed signals having the same set of wavelengths as the input multiplex signal, and each optical switch of the portion of M optical switches is configured to receive one output multiplexed signal from each of the optical splitters of the portion of the N optical splitters, select one of the output multiplexed signals, and output the selected output multiplexed signal; and an add section, comprising a second portion of the N optical splitters and M optical switches, wherein up to the second portion of M optical switches are configured to receive an optical signal having a set of wavelengths and output the received optical signal to one of the second portion of N optical splitters, each the second portion of N optical splitters is configured to combine the optical signals received from the optical switches into a single multiplexed signal containing the sets of wavelengths provided by the optical signals received by the optical splitter.

The K×(N×M) optical switching system may further include K number of optical amplifiers, each optically connected to one of the 1 ×X optical splitters.

The K×(N×M) optical switching system may further include up to M number of optical amplifiers, each optically connected to one of the optical switches.

In another aspect, a method for dropping signals is provided that includes receiving an input multiplexed signal having a set of wavelengths into a 1 ×Y optical splitter; splitting the input multiplexed signal into a number Y of output multiplexed signals, each output multiplexed signals having the same set of wavelengths as the input multiplex signal, sending each of the Y output multiplexed signals into a different one of a plurality of Z×1 optical switches, selecting one of the Y output multiplexed signals at the Z×1 optical switch; and outputting the selected output multiplexed signal.

A method of adding optical signals includes receiving 2 or more optical input signals each at a separate optical switch, each optical input signal having a set of one or more wavelengths, outputting each optical input signal from the optical switches to an optical splitters, and combining in the optical splitter the optical input signals received from each of the optical switches into a single multiplexed signal containing the sets of wavelengths provided by the optical input signals.

### DESCRIPTION OF THE DRAWINGS

FIG. 1A illustrates an embodiment of a 4×8 Switch Structure capable of producing single-wavelength output signals.

FIG. 1B illustrates another embodiment of a 4×8 Switch Structure that produces multiplexed output signals.

FIG. 2 illustrates wavelengths entering and exiting one of the Tunable Splitters in the 4×8 Switch Structure of FIG. 1A.

FIG. 3 illustrates the function of an Optical Switch in the 4×8 Switch Structure of FIG. 1A.

FIG. 4 illustrates the function of a Tunable Filter in the 4×8 Switch Structure of FIG. 1A.

FIGS. 5A and 5B illustrate partially directionless optical switch systems.

FIG. 6 depicts an embodiment of an expanded switch structure incorporating the 4×8 Switch Structure of FIG. 1A.

FIG. 7 shows an optical switching system module usable for both adding and dropping signals in an optical network.

FIG. 8 illustrates an embodiment of an expanded switch structure incorporating the optical switching system module of FIG. 7.

FIG. 9A illustrates an embodiment in which amplifier arrays are included in an optical switch system which has an M=8 and N=8 structure.

FIG. 9B illustrates an embodiment in which the optical switching system module that is used in a K×(M×N) structure includes amplifiers.

FIG. 10A shows an embodiment of a K×(N×M) optical switching system in which a number of tunable filter/amplifier modules can be added to the system as needed to expand the system.

FIG. 10B shows a tunable filter/amplifier module in which second amplifier arrays are used.

FIG. 11 shows another embodiment of an optical switching system that uses modules containing switches, amplifiers and tuners to provide additional modularity to the optical switching system.

FIG. 12 illustrates a module containing switches, amplifiers and tuners.

### DETAILED DESCRIPTION

In the following description, reference is made to the accompanying drawings which illustrate different embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

It will be understood that when an element is referred to as being “on”, “connected to” or “coupled to” another element, it can be directly on, connected or coupled to the other element or intervening elements or layers may be present.

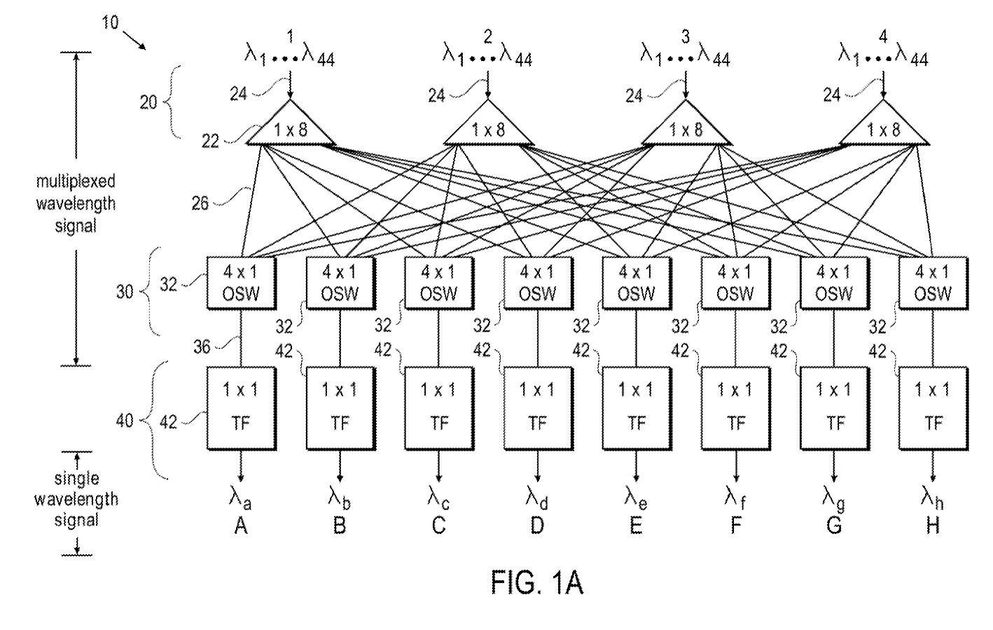

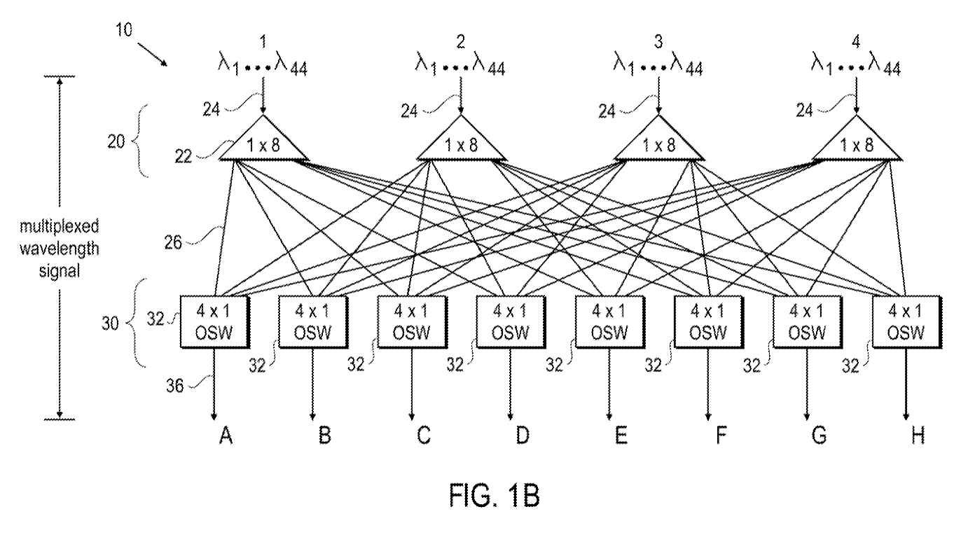

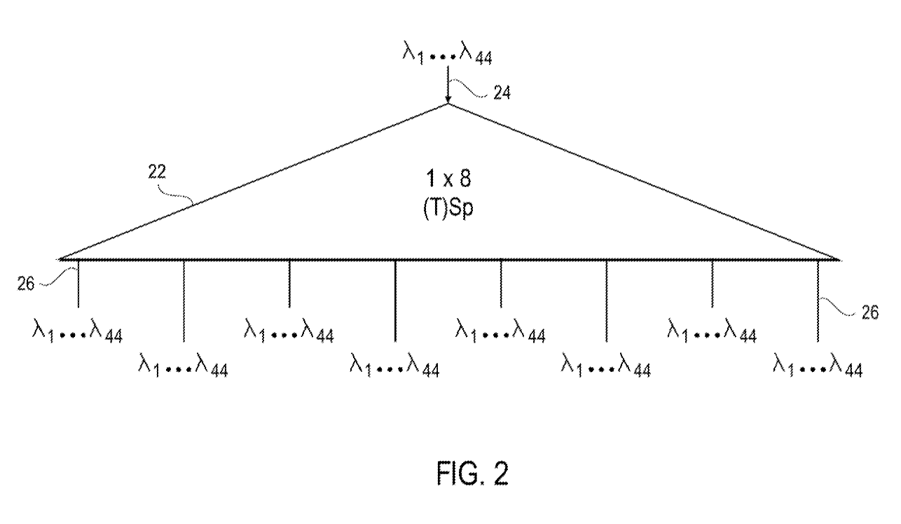

FIG. 1A shows an optical switch system 10 usable for dropping a ROADM node in an optical network. As shown, the optical switch system 10 has an N×M structure where N denotes the number of input ports and M denotes the number of output ports. In the embodiment of FIG. 1A, there are N=4 input ports 1 through 4 and M=8 output ports A through H. The switch system 10 has three stages: a first stage 20, a second stage 30, and a third stage 40. The first stage 20 includes N number of 1 ×M optical splitters 22. Each one of the optical splitters 22 receives a multiplexed input signal 24 and splits the multiplexed input signal 24 into M pieces of multiplexed first output signals 26. The split ratio in the optical splitters 22 can be either fixed or adjustable (tunable). FIG. 2, described below, provides more details about each 1 ×M splitter 22

Depending on the embodiment, either a regular splitter may be used or a Tunable Splitter Tsp may be used as the optical splitters in the first stage 20. A “tunable splitter,” as used herein, includes splitters that allow control over both the number of output ports and the portion of each output port. No wavelength selection is done by a tunable splitter. A regular splitter is one in which the splitting ratio is fixed.

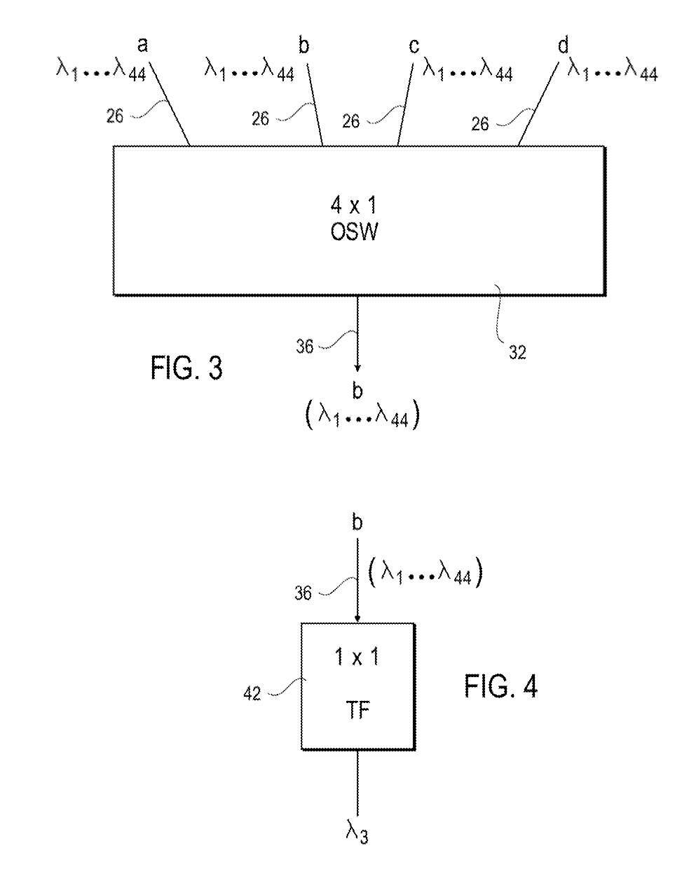

The second stage 30 includes M number of N×1 switches 32. The switches 32 receive the first output signals 26 that come out of the first stage 20. Each switch 32 selects one of the four incoming signals 26 and forwards it to the third stage 40 as a second output signal 36. Both the signals entering the second stage 30 and exiting the second stage 30 are multiplexed. FIG. 3, described below, provides more details about each N×1 switch 32.

The third stage 40 includes a plurality of optical tunable filters 42. The number of optical tunable filters 42 is the same as that of the N×1 switches 32. Each tunable filter 42 selects one wavelength from the received second output signal 36 and passes the selected wavelength out of the switch structure 10 in the form of switch structure output signal 46. The optical switch system 10 re-routes or switches multiplexed input signals 24 that are fed into the N input ports into M number of single-wavelength (i.e., not multiplexed) switch structure output signals 46. Different tunable filters 42 may output the same wavelength but these wavelengths originated from different input signals 24. FIG. 4, described below, provides more details about each tunable filter 42.

The invention affords more flexibility to the Drop end of the ROADM system. Any wavelength fed into any input port can be freely selected and dropped to any output port. ROADM nodes in the network will become directionless, colorless and contentionless.

FIG. 1B illustrates another embodiment of a 4×8 Switch Structure. This switch system 10 of FIG. 1B is similar to the embodiment shown in FIG. 1A except that it produces multiplexed output signals. The switch system 10 has the first stage 20 and the second stage 30, but no third stage 40. Hence, this switch structure functions as an N×M switch but does not provide the wavelength selection option like the embodiment of FIG. 1A.

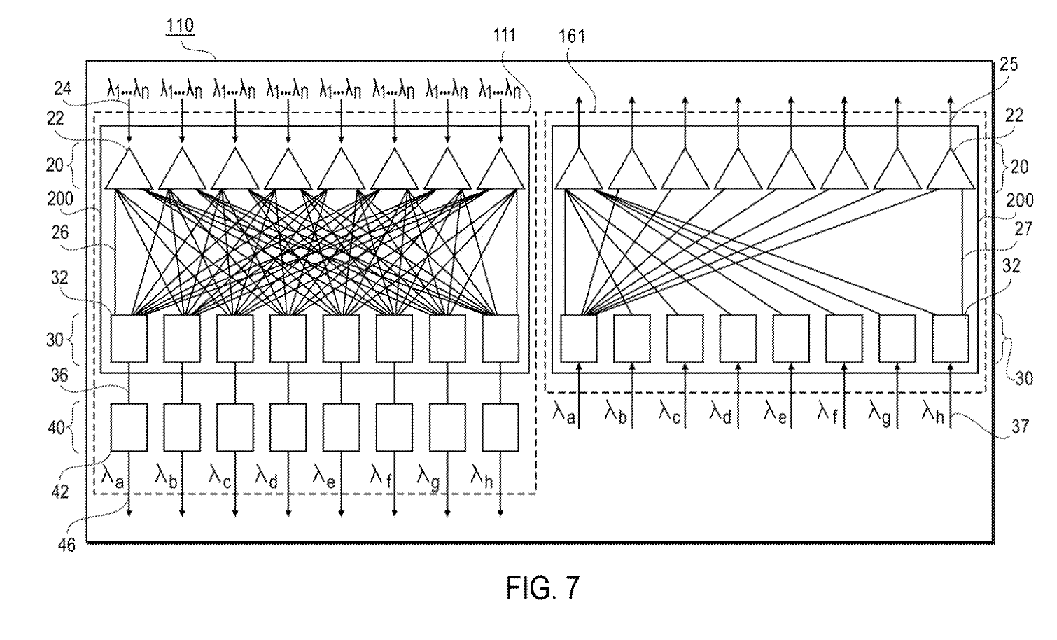

As will be described in more detail below with respect to FIG. 7, the optical switching system 10 of FIGS. 1A and 1B can also be used to combine signals. That is, single wavelength signals A-H enter optical switches 32, which can forward the single wavelength signal to one of the optical splitters 22. Optical splitters 22 function as combiners, and combine any single wavelength signals received into a multiplexed signal, which is output from the optical splitter 22.

FIG. 2 illustrates wavelengths entering and exiting one of the optical splitters 22 in the 4×8 Switch Structure 10 of FIG. 1A. In the particular example where M=8, the multiplexed signal 24 entering the 1×8 optical splitter has 44 wavelengths 21 through 2A4. In many cases, the input signals 24 entering the different optical splitters in the first stage 20 all carry the same set of wavelengths. However, this is not a limitation of the invention and each port may carry different wavelengths, different number of wavelengths, or a different range of wavelengths as the other input ports. The number of wavelengths entering a single 1×8 splitter 22 is not limited to being 44, and this number could also be 1 , i.e., single wavelength signals. As discussed above, the optical splitter 22 may be tunable splitter Tsp, as shown in FIG. 2, or it may be a regular optical splitter.

As shown in FIG. 2, there are eight signals 26 exiting the Tunable splitter Tsp. Each of the eight signals 26 contains the same multiplexed wavelengths as the input signal 24 that was fed into the same Tunable splitter Tsp.

FIG. 3 illustrates the function of an Optical Switch in the 4×8 switching system of FIG. 1A. As there are four splitters in the first stage 20, each switch 32 receives four first output signals 26, one from each splitter. Each switch 32 selects one of the four incoming signals 26 (illustrated as signals a, b, c, and d in FIG. 3) and forwards it to the third stage 40 as a second output signal 36. In the example of FIG. 3, signal b is selected. Signal b is a multiplexed signal as no wavelength selection occurs in stage 30.

FIG. 4 illustrates the function of a Tunable Filter in the 4×8 switching system of FIG. 1A. Exiting each Tunable Filter TF is a single wavelength from the multiplexed input signal 24. Where different wavelengths are fed into the multiple tunable splitters Tsp, the output signal exiting one of the Tunable Filters TF may be a wavelength from a multiplexed input signal 24 that was fed into any one of the Tunable Filters TF. The Tunable Filters 24 receive multiplexed signals 36 and generate single-wavelength outputs (e.g., 2J in FIG. 4). Prior to reaching the Tunable Filters 24, any one of the four input signals 24 may be redirected to any one of the eight multiplexed wavelength signal paths.

The N×M switch structure illustrated in FIGS. 1A and 1B is fully directionless, having N number of 1 ×M optical splitters 22 and M number of N×1 switches 32. In this way, any of the N multiplexed input signals 24 can be directed to all or any number of the M ports. For example, considering just the multiplexed input signal 24 entering input port 1, it is split into 8 parts of multiplexed first output signals 26 by the 1×8 switch 22, where 8 is the number of output ports a through h. The optical splitters 22 are optically connected to each of the switches 32 at output ports a through h, such that each optical splitter 22 has a connection to each switch. Thus, one of each of the 8 parts of the first output signal 26 from input port 1 is received by each of the 8 4×1 switches a through h. Thus, any combination of switches 32 can output signal from input port 1. This is also the case for multiplexed input signals 24 received at input ports 2, 3 and 4.

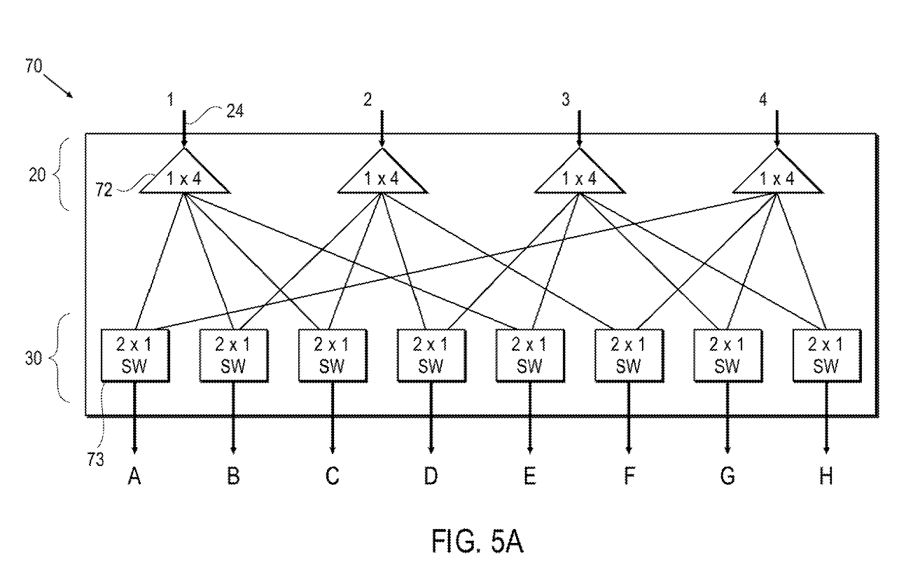

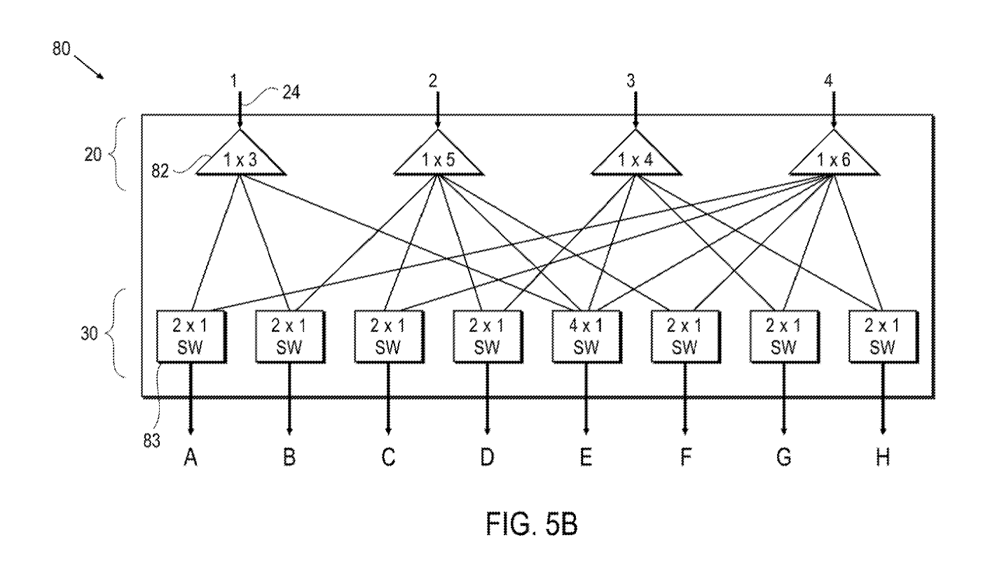

However, certain applications may not require a switch structure to be fully directionless. For example, FIG. 5A illustrates a partially directionless optical switch system 70 having, in this example N=4 input ports 1 through 4 and M=8 output ports A through H. In this example, however, the user only needs for the multiplexed input signal 24 entering input port 1 to go to output ports A, B, C and/or E, the multiplexed input signal 24 entering input port 2 to go to output ports B, C, D and/or F, the signal 24 entering input port 3 to go to output ports D, E, G and/or H, and the multiplexed input signal 24 entering input port 4 to go to output ports A, F, G and/or H. Thus, a sufficient structure includes, as illustrated, 4 1×4 optical splitters 72 (which may be regular or tunable splitters) in the first stage 20 and 8 2×1 switches 73 in the second stage 30, which are optically connected as illustrated in FIG. 5A.

Another embodiment of a partially directionless optical switch system is illustrated in FIG. 5B. Optical switch system 80 has N=4 input ports 1 through 4 and M=8 output ports A through H. In this example, the user only needs, for example, the multiplexed input signal 24 entering input port 1 to go to output ports A, B and/or E, the multiplexed input signal 24 entering input port 2 to go to output ports B, C, D, E and/or F, the multiplexed input signal 24 entering input port 3 to go to output ports D, E, G and/or H, and the multiplexed input signal 24 entering input port 4 to go to output ports A, C, E, F, G and/or H. Thus, a sufficient structure includes 1×3, 1×5, 1×4 and 1×6 optical splitters 82 (which may be regular or tunable splitters) connected, respectively, to input ports 1 through 4 in the first stage, and 8 2×1 optical switches 83 at output ports A through H in the second stage and optically connected as illustrated in FIG. 5B.

Generally, then, an optical switching system that can be used to switch signals between N first ports and M second ports will contain N number of 1 ×Y splitters in the first stage, where Y can be any natural number, typically a number between 1 and M, and M number of Z×1 switches in the second stage, where Z can be any natural number, typically a number between 1 and N. In the second stage 30, the number Z for each switch (73, 83) is the number of splitters (72, 82) to which the switch (73, 83) is connected. For an optical switching system to be directionless, so that any signal at a port N can be switched to any port M, as illustrated in FIGS. 1A and 1B, Y=M and Z=N, and each optical splitter is optically connected to each optical switch.

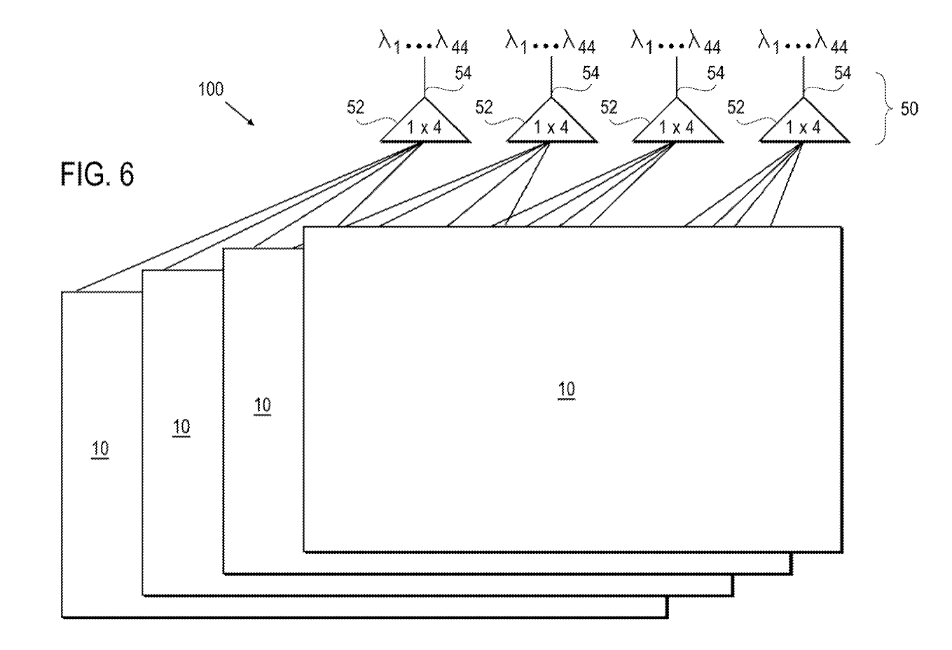

FIG. 6 shows an embodiment of a K×(N×M) optical switch system 100 that offers even more flexibility to signal routing, and illustrates how the optical switching system can be combined and/or layered to suit an application. The embodiment shown in FIG. 6 is substantially similar to that shown in FIG. 1A, with a primary difference being the addition of a fourth stage 50 before the first stage 20. In the particular embodiment of FIG. 6, the fourth stage 50 has 4 1×4 optical splitters 52, such that there are four N×M switch structures 10. As shown, the fourth stage 50 “ties together” a plurality of switch structures 10. The addition of the fourth stage 50 makes the optical switch structure 100 a K×(N×M) switch structure.

The fourth stage 50 includes a group of 1×4 optical splitters 52, which may be regular or tunable splitters. Each one of the optical splitters 52 receives an original signal 54 and splits the original signal 54 into up to 4 pieces or branches. If a tunable splitter is used, and only one N×M switching structure 10 is connected, then only one branch of each of the tunable splitters 52 will be set to pass while the others will be blocked to avoid unnecessary splitting. Similarly, if two N×M structures are needed, then two branches of each of the tunable splitters 52 will be set to pass the signals while others will be blocked. The number of N×M structures can keep increasing up to the number of branches (channels) that the optical splitters 52 split the original signal 54.

The switch structures 10 are typically fully directionless, such as those illustrated in FIGS. 1A or 1B, but may also be partially directionless, such as illustrated in FIGS. 5A or 5B. The fourth stage 50, in general terms, has K number of 1 ×X optical splitters 52. For the K(N×M) structure to be fully directionless, each channel X of optical splitters 52 must be optically connected to one of the N optical splitters in first stage 20 of a different N×M structure 10 , and the switch structure 10 must be fully directionless. Typically, a switch structure 10 has N=K number of optical switches so that each of the K optical splitters in the fourth stage 50 is optically connected to an optical splitter in the first stage 20 within a single switch structure 10. In such case, up to X number of switch structures 10 may be added to the fourth stage 50.

Depending on the application, the system can adjust the number of N×M structure 10 sets needed to be installed. For example, the user can install one N×M structure 10 first. In this case, if optical splitter 52 is a tunable splitter, each tunable splitter in the stage 50 will be tuned so that only one branch goes out (i.e., no splitting). Later, as the network grows, the system user may like to add another N×M structure 10. At this point, the user will only need to adjust the tunable splitter 52 to make it pass out 2 branches (i.e., 1×2 splitter), and the addition branch will go to the additional N×M structure 10. The system can keep growing like this up to a plurality (X) of N×M structures 10 together.

FIG. 7 shows an optical switching system add/drop module 110 usable for both adding and dropping signals in an optical network. The optical switching add/drop module 110 has a drop section 111 and an add section 161.

The drop section 111 of the optical switching system add/drop module 110 has the structure of the optical switch system 10 illustrated in FIG. 1A, with a first stage 20, a second stage 30, and a third stage 40. An exemplary embodiment in which N=8 and M=8 is illustrated. In drop section 111, N=8 multiplexed input signals 24 each having multiplexed wavelengths of λ1 . . . λn are fed into N=8 optical splitters 22. The N=8 optical splitters 22 split the multiplexed input signals 24 into M=8 pieces of multiplexed first output signals 26, each of which contains the λ1 . . . λn wavelengths.

The optical splitters 22 are optically connected to M=8 switches 32 such that each optical splitter 22 has a connection to each switch 32. Optical switches 32 each receive one multiplexed first output signal 26 from the optical splitters 22. Each optical switch 32 selects one of the M=8 incoming multiplexed first output signals 26 and outputs the selected signal as a second output signal 36, which remains multiplexed and thus contains the λ1 . . . λn wavelengths.

The optical switches 32 are optically connected to M=8 tunable filters 42. The M=8 tunable filters 42 receive the M=8 multiplexed second output signals 36 and each tunable filter 42 selects one wavelength from the received second output signal 36 and passes it out of the optical switching add/drop module 110 as output signal 46, having one of the wavelengths λa to λh.

The add section 161 of the optical switching system add/drop module 110 is used for switching and combining input signals. The input signals may be individual wavelengths or may be multiplexed signals having more than one wavelength. Add section 161 has the structure of the optical switch system illustrated in FIG. 1B, with a first stage 20 and a second stage 30. An exemplary embodiment in which N=8 and M=8 is illustrated. Up to M=8 first input signals 37 can be fed into the add section 161. Each first input signal 37 has a set of wavelengths, which may be an individual wavelength, and is fed into one of M=8 optical switches 32 such that the M ports on optical switches 32 are input ports. Each optical switches 32 is optically connected to N=8 optical splitters 22. Thus, each optical switch 32 can output the input signal 37 to one of the optical splitters 22 at any given time. For instance, the first input signal λa entering optical switch 32 can be output to one of 8 possible optical splitters 22. For clarity of illustration, not all of the optical connections between each optical switch 32 and optical splitter 22 are shown in FIG. 7.

In add section 161, optical splitters 22 may function as combiners, capable of combining input signals 37 received from different optical switches 32 into a single output signal 25. Each of the optical splitters 22 may receive up to N=8 input signals 37 and combine them into up to N=8 single multiplexed signals 25. The single multiplexed signals 25 are output from the optical splitters 22 such that the N ports on the optical splitters 22 are output ports. The output signals 25 of each of optical splitters 22 are likely to be different from each other, and may contain any combination of the input signals 37. Or an optical splitter 22 may have no output signal. In FIG. 7, the input signals 37 are shown as individual wavelengths λa to λh. However, as noted the input signals may contain more than one wavelength. So, for example, an input signal received at optical switch A may contain 3 wavelengths λ1 to λ3 and an input signal received at optical switch D may contain 10 wavelengths λ4 to λ13. If optical switch A and optical switch D both output the input signals to the same optical splitter (for example, optical splitter B) then the output signal of optical splitter B would be a multiplexed signal containing the combination of wavelengths λ1 to λ13.

FIG. 7 also shows that the N optical splitters 22 and M optical switches 32 in both the drop section 111 and add section 161 are combined into units 200, which can be referred to as N×M multicast switch modules. Additionally, although switching system add/drop module 110 is illustrated as fully directionless, it may alternatively employ partially directionless structures as described with respect to FIGS. 5A and 5B. Optical splitters 22 may be regular or tunable splitters.

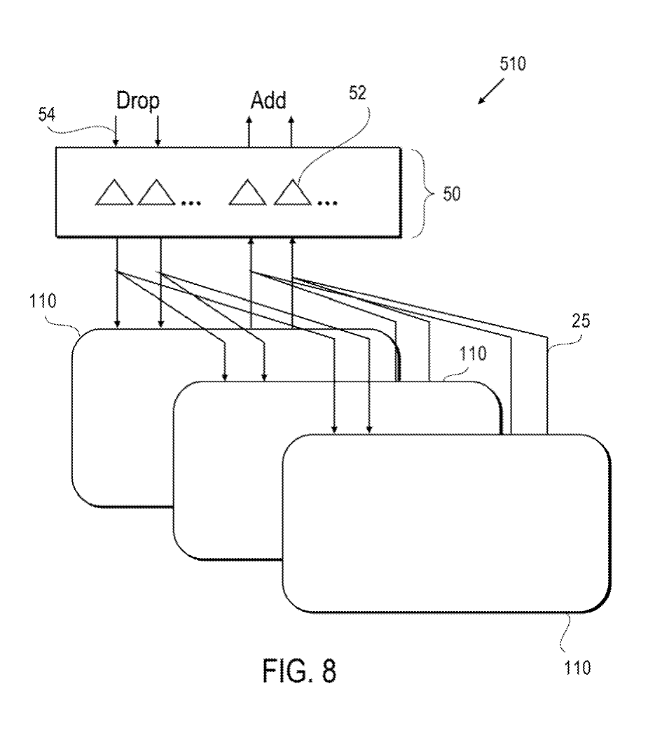

As illustrated in FIG. 8, the optical switching system add/drop module 110 can also be used with the K×(N×M) structure 510 in which K optical splitters 52, which may be regular or tunable splitters, in the fourth stage 50 may be used to split or further combine signals. Input signals 54 may, for example, be split by optical splitters 52 in the fourth stage 50 and then fed into a drop section 111 of an optically connected optical switching system add/drop module 110. Multiplexed signals 25 that are output from an add section 161 of an optical switching system add/drop module 110 may, for example, be further combined in a fourth stage 50 that is optically connected to the optical switching system add/drop module 110.

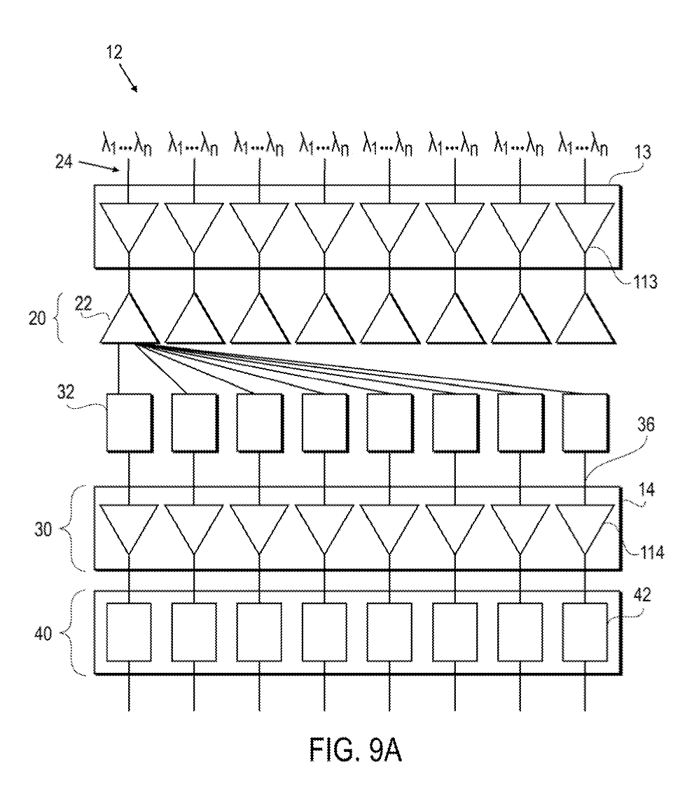

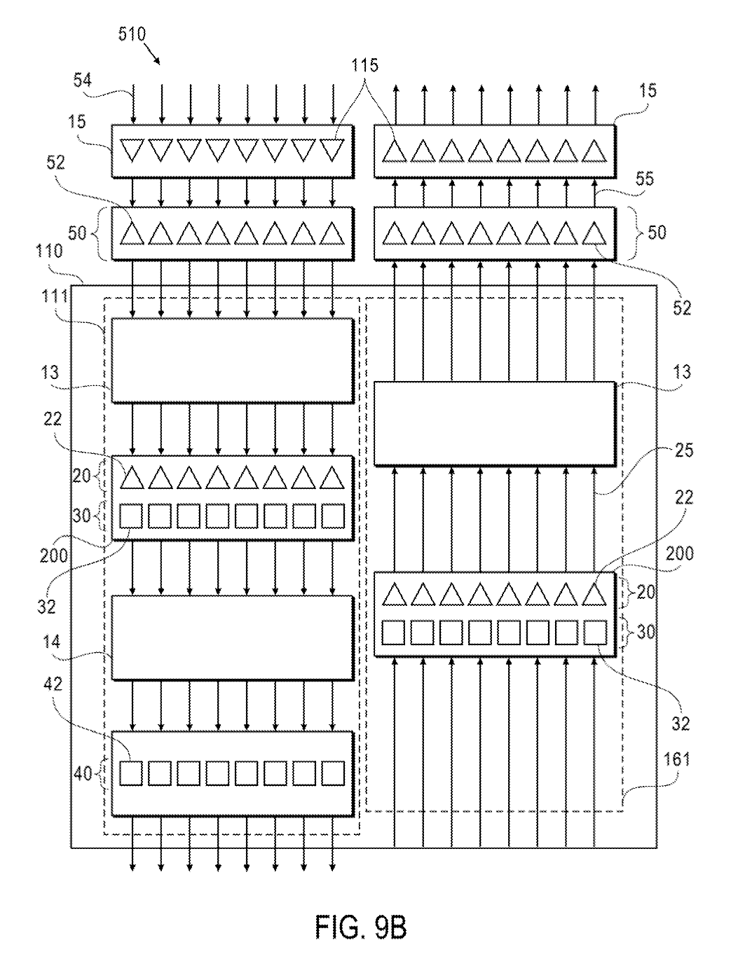

As signals pass through the optical switching systems, a significant amount of insertion loss may occur. FIG. 9A illustrates an embodiment in which amplifier arrays are included in an optical switch system 12 which has an M=8 and N=8 structure (for clarity of illustration not all signals between optical switch 32 and optical splitter 22 are shown in FIG. 9A). A first amplifier array 13 in an N x M structure includes N amplifiers 113 inserted before and optically connected to optical splitters 22, such that each of the N multiplexed input signals 24 is amplified before being fed into optical splitters 22. A second amplifier array 14 having M amplifiers 114 may also be inserted between and optically connected to the M optical switches 32 and the M tunable filters 42, so that each of the second output signals 36 is amplified before being fed into the tunable filters 42. Alternatively, the second amplifier array 14 may be included in the optical switching system 12 after the tunable filters 42.

FIG. 9B illustrates an embodiment in which optical switching system add/drop module 110 used in a K×(M×N) structure 510 having a stage 50 includes amplifiers. The drop section 111 includes first and second amplifier arrays 13 and 14 as illustrated in FIG. 9A. The add section 161 includes a first amplifier array 13, inserted after and optically connected to splitters 22, to amplify multiplexed signals 25 output from optical splitters 22. In the fourth stage 50, an amplifier array 15 having amplifiers 115 may be inserted before and optically connected to the K optical splitters 52 to amplify signals 54 entering the drop section 111 and amplify signals 55 leaving the add section 161. Alternatively, amplifiers 15 can be placed after optical splitters 52 in the drop section 111 and before the optical splitters 50 in the add section 161. Each optical amplifier 113, 114, 115 used in the amplifier arrays may be, for example, an erbium doped fiber amplifier EDFA.

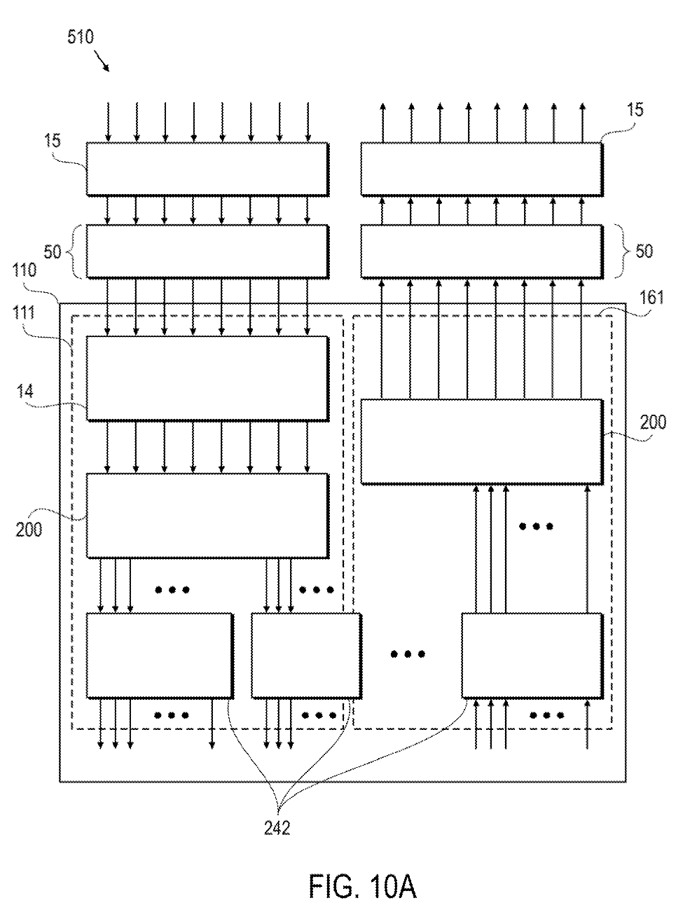

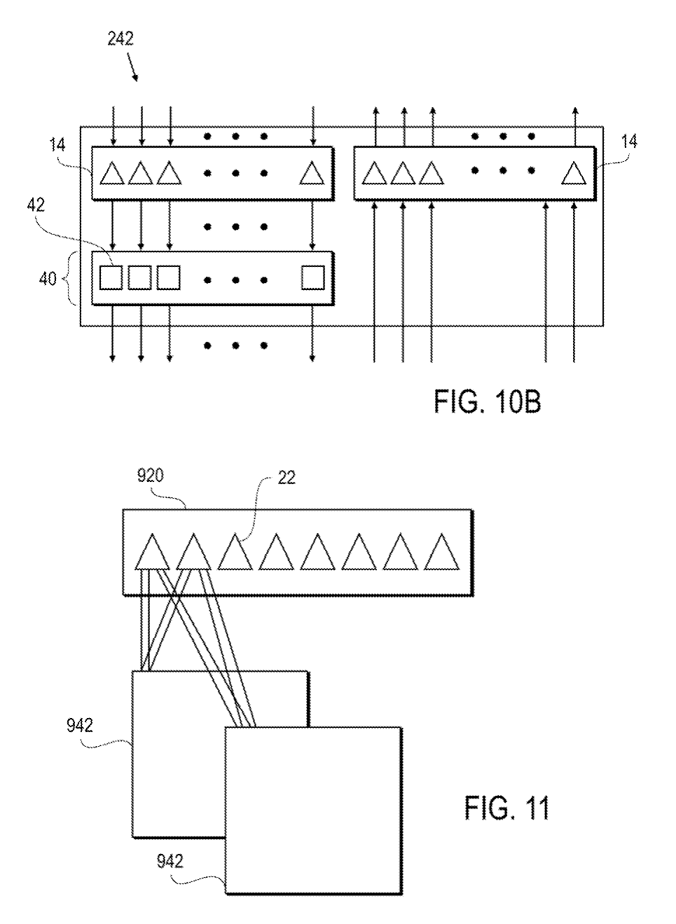

In addition to the system modularity provided by fourth stage 50 (FIGS. 6 and 8), additional modularity may be included in an optical switching system via the opposite end of the optical switching system. FIG. 10A shows an embodiment of a K×(N×M) optical switching system 510 in which a number of tunable filter/amplifier modules 242 can be added to the optical switching system add/drop module 110 as needed to expand the system. Tunable filter/amplifier modules 242 can be optically connected to the multicast switch modules 200, and can be attached and detached from the multicast switch modules 200 as a unit. Tunable filter/amplifier modules typically have less than the full number of channels on module 200 of tunable filters and amplifiers, so that they can be added as the need for more channels arises. The optical switching system 510 has, in this exemplary embodiment, 8 drop channels and 8 add channels at stage 50, each feeding into, for example, an 8 x 96 multicast switch module 200 (as illustrated in FIG. 7) in optical switching system add/drop module 110. Each tunable filter/amplifier module 242 may have, for example, T number of tunable filters/amplifiers, which are each optically connected to one of the optical switches in the multicast switch module 200. In general, the total number P of tunable filter/amplifier modules 242 that can be attached to a multicast switch module 200 is equal to M/T. Thus, in the system in FIG. 10A, if, for example, each tunable filter/amplifier module contained T =16 tunable filter/amplifiers, up to P =6 tunable filter/amplifier modules 242 can be used for one 8 x 96 multicast switch module 200 (96/16=6). So, for example, in an initial installment of such an optical switching system 510, one 8×96 multicast switching module 200 may be used with one tunable filter/amplifier module 242 for an 8×(8×16) structure to provide add/drop for 16 channels. Tunable filter amplifier modules 242 may be added until all of the channels of the multicast switching module 200 are in use.

FIG. 10B shows a tunable filter/amplifier module 242 in which second amplifier arrays 14 are used, and one of the second amplifier arrays is optically connected with an array of tunable filters 42, for use when signals are to be dropped.

FIG. 11 shows another embodiment of an optical switching system having additional modularity in which, instead of the having the optical splitters 22 and optical switches 32 combined into a multicast switch unit 200, as illustrated in FIG. 7, the optical switches, amplifiers and tunable filters are all included in a single module, which is the SW-AMP-TF module 942. The optical splitters 22 are included in a splitter array 920, to which a number of SW-AMP-TF modules 942 may be attached as the need for more output ports arises.

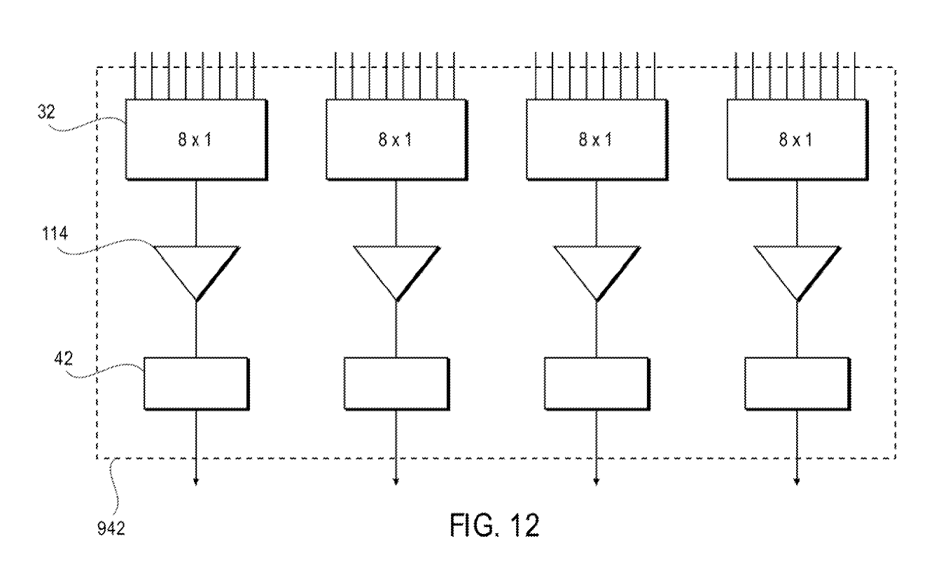

FIG. 12 illustrates an SW-AMP-TF module having, in this exemplary embodiment, 4 8×1 switches 32, optically connected to 4 amplifiers 114 and 4 tunable filters 42. The number of optical switches 32 in each SW-AMP-TF module, along with the optically connected amplifiers 114 and tunable filters can be varied. Depending on the embodiment, the SW-AMP-TF module 942 can also be a module containing just switches 32, a module containing switches 32 and amplifiers 114, or a module containing switches 32 and tunable filters 42.

Referring to FIG. 11, the optical splitters 22 in the splitter arrays 920, which may be regular or tunable splitters Tsp, are typically each optically connected to at least one SW-AMP-TF module 942(not all connections are shown in FIG. 11 for clarity) . The number of SW-AMP-TF modules 942 connected to the splitter array 920 can be varied, and depends on the number of switches 32 in the SW-AMP-TF modules. For example, in an exemplary embodiment of an optical switching system, each splitter array 920 may contain 8 1×96 splitters 22. A SW-AMP-TF module 942 may contain 16 8x1 switches 32, optically connected to 16 amplifiers 114 and 16 tunable filters 42. Such a SW-AMP-TF module 942 may be connected to the splitter array 920 to receive signals from channels #1 to #16 of each of the 8 1x96 splitters. A second SW-AMP-TF module 942 may be connected to receive the signals from the next 17-32 channels from each of the 8 1×96 splitters, etc. Up to 6 such SW-AMP-TF modules 942 may be connected to one splitter array 920, that is 96/16=6.

In general terms, each splitter array 920 contains a number, for instance N, of 1 ×M optical splitters 22 and therefore, if the switches 32 in SW-AMP-TF module 942 are N×1 switches, a splitter array 920 can accept up to M number of switches 32 (as shown in the N×M structure in FIG. 1A). The SW-AMP-TF module 942 typically contains R number of N×1 switches 32 (as well as amplifiers 114 and tunable filters 42), where R is typically a number that can be divided equally into M. Thus, the total number of SW-AMP-TF module 942 that a splitter array 920 may contain is M/R=Q.

SW-AMP-TF modules 942 may be used with K×(N×M) systems, such as those shown in FIG. 8. If used with a K (N×M) system the optical splitter array module 920 will typically include K optical splitters 22 which may be connected to a stage 50 as shown in FIG. 8. A number of such splitter arrays 920 can be connected to stage 50 to provide the same modularity as illustrated in FIG. 8.

It should be understood that the invention can be practiced with modification and alteration within the spirit and scope of the disclosure. The description is not intended to be exhaustive or to limit the invention to the precise form disclosed.

What is claimed is:

1. An optical switching system for switching optical signals between N first ports and M second ports comprising:
N number of 1 ×Y optical splitters, each optical splitter providing one of the N first ports; and
M number of Z×1 optical switches, each optical switch optically connected to at least one optical splitter and providing one of the M second ports,
wherein Y is any natural number and Z is any natural number.

2. The optical switching system of claim 1, wherein Z is the number of optical splitters to which an optical switch is optically connected.

3. The optical switching system of claim 1, wherein Y equals M, Z equals N, and each optical splitter is optically connected to each optical switch.

4. The optical switching system of claim 1, wherein Y is the same for each optical splitter.

5. The optical switching system of claim 1, wherein Y for one of the optical splitters is the same or different as Y for the other N number of optical splitters.

6. The optical switching system of claim 1, wherein Z is the same for each optical switch.

7. The optical switching system of claim 1, wherein Z is for one of the optical switches is the same or different as Z for the other M number of optical switches.

8. The optical switching system of claim 1, wherein each of the optical splitters is configured to receive an input multiplexed signal having a set of wavelengths and to split the input multiplexed signal into Y number of output multiplexed signals, and
each of the optical switches is configured to receive one output multiplexed signal from 1 to N number of the optical splitters, to select one of the 1 to N number of output multiplexed signals received, and to output the selected output multiplexed signal.

9. The optical switching system of claim 1, further comprising tunable filters, each of the tunable filters optically connected to one of the M number of optical switches and capable of passing a preselected wavelength range from a selected multiplexed signal received by the tunable filter.

10. The optical switching system of claim 9, further comprising:
up to M number of optical amplifiers each optically connected to one of the optical switches and one of the tunable filters.

11. The optical switching system of claim 9, further comprising:
up to M number of optical amplifiers, each optically connected to one of the tunable filters.

12. The optical switching system of claim 1, wherein each of the optical switches is configured to receive an input signal the input signal having a set of wavelengths that is the same or different for each optical switch, to select one of the N number of optical splitters to output the input signal to, and to output the input signal to one of the N number of optical splitters, and each of the optical splitters is configured to receive one or more input signals and output a multiplexed signal containing a group of wavelengths that includes the sets of wavelengths provided by the input signals received by the optical splitter.

13. The optical switching system of claim 12 wherein the set of wavelengths for one or more of the input signals is a single wavelength.

14. The optical switching system of claim 1 further comprising:
up to N number of optical amplifiers, each optically connected to one of the optical splitters.

15. The optical switching system of claim 1, further comprising:
up to N number of optical amplifiers, each optically connected to one of the optical switches and one of the optical splitters.

16. The optical switching system of claim 1 further comprising
up to P tunable filter modules, each tunable filter module including T number of tunable filters capable of passing a preselected wavelength range from a selected multiplexed signal received by the tunable filter, each tunable filter module capable of being attached and detached from the T optical switches as a unit to optically connect each of the T number of tunable filters to one of the M number of optical switches, where T<M and P=M/T.

17. The optical switching system of claim 16, wherein the tunable filter module further comprises T number of amplifiers each optically connected to one of the tunable filters.

18. The optical switching system of claim 1, further comprising:
a drop section, comprising a portion of the N optical splitters and the M optical switches, wherein each optical splitter of the portion of the N optical splitters is configured to receive an input multiplexed signal having a set of wavelengths and split the input multiplexed signal into Y number of output multiplexed signals, each of the output multiplexed signals having the same set of wavelengths as the input multiplex signal, and each optical switch of the portion of M optical switches is configured to receive one output multiplexed signal from each of the optical splitters of the portion of the N optical splitters, select one of the output multiplexed signals, and output the selected output multiplexed signal; and
an add section, comprising a second portion of the N optical splitters and M optical switches, wherein up to the second portion of M optical switches are configured to receive an optical signal having a set of wavelengths and output the received optical signal to one of the second portion of N optical splitters, each the second portion of N optical splitters is configured to combine the signals received from the optical switches into a single multiplexed signal containing the sets of wavelengths provided by the optical signals received by the optical splitter.

19. The optical switching system of claim 18, further comprising: up to Q tunable filters, each tunable filter optically connected to one of the portion of M number of optical switches and capable of passing a preselected wavelength range from a selected multiplexed signal received by the tunable filter.

20. The optical switching system of claim 1, wherein the optical splitters are combined into a splitter array unit and the optical switches are combined into an optical switch module, and the optical switch module can be attached and detached from the splitter array unit.

21. The optical switching system of claim 20, wherein the optical switch module further comprises a plurality of tunable filters, one tunable filter optically connected to each optical switch and each tunable filter capable of passing a preselected wavelength range from a selected multiplexed signal received by the tunable filter.

22. The optical switching system of claim 20, wherein the optical switch module further comprises a plurality of amplifiers, each amplifier optically connected to each optical switch.

23. The optical switching system of claim 1, further comprising:
a plurality of 1 ×X optical splitters, wherein each 1 ×X optical splitter is optically connected to the input port of each of the N 1 ×Y optical splitters.

24. A K×(N×M) optical switching system, comprising:
K number of 1 ×X optical splitters, where X is any natural number;
N number of 1 ×Y optical splitters, where Y is any natural number; and
M number of Z×1 optical switches, where Z is any natural number, wherein each of the 1×Y optical splitters is optically connected to a different channel X of the 1 ×X optical splitters, and each of the Z channels of each optical switch is optically connected to different 1 ×Y optical splitter.

25. The K×(N×M) optical switching system of claim 24, wherein N=(K)(X).

26. The K×(N×M) optical switching system of claim 24, wherein Y equals M, Z equals N, and each optical splitter is optically connected to each optical switch.

27. The K×(N×M) optical switching system of claim 24, further comprising a plurality of tunable filters each connected to one of the Z×1 optical switches.

28. The K×(N×M) optical switching system of claim 24, further comprising:
a drop section, comprising a portion of the N optical splitters and the M optical switches, wherein each optical splitter of the portion of the N optical splitters is configured to receive an input multiplexed signal having a set of wavelengths and split the input multiplexed signal into Y number of output multiplexed signals, each of the output multiplexed signals having the same set of wavelengths as the input multiplex signal, and each optical switch of the portion of M optical switches is configured to receive one output multiplexed signal from each of the optical splitters of the portion of the N optical splitters, select one of the output multiplexed signals, and output the selected output multiplexed signal; and
an add section, comprising a second portion of the N optical splitters and M optical switches, wherein up to the second portion of M optical switches are configured to receive an optical signal having a set of wavelengths and output the received optical signal to one of the second portion of N optical splitters, each the second portion of N optical splitters is configured to combine the signals received from the optical switches into a single multiplexed signal containing the sets of wavelengths provided by the optical signals received by the optical splitter.

29. The K×(N×M) optical switching system of claim 28 wherein the set of wavelengths for one or more of the optical signals is a single wavelength.

30. The K×(N×M) optical switching system of claim 24 further comprising:
up to K number of optical amplifiers, each optically connected to one of the 1×X optical splitters.

31. The K×(N×M) optical switching system of claim 24, further comprising:
up to M number of optical amplifiers, each optically connected to one of the optical switches.

32. A method of dropping optical signals comprising:
receiving an input multiplexed signal having a set of wavelengths into a 1 ×Y optical splitter;
splitting the input multiplexed signal into a number Y of output multiplexed signals, each output multiplexed signals having the same set of wavelengths as the input multiplex signal;
sending each of the Y output multiplexed signals into a different one of a plurality of Z×1 optical switches;
selecting one of the Y output multiplexed signals at the Z×1 optical switch; and
outputting the selected output multiplexed signal.

33. A method of adding optical signals comprising:
receiving 2 or more optical input signals each at a separate optical switch, each optical input signal having a set of one or more wavelengths;
outputting each optical input signal from the optical switches to an optical splitters; and
combining in the optical splitter the optical input signals received from each of the optical switches into a single multiplexed signal containing the sets of wavelengths provided by the optical input signals.
